(19) United States
(12) Patent Application Publication
(10) Pub. No.: US 2008/0196087 A1
(43) Pub. Date: Aug. 14, 2008

(54) Peer-to-Peer Distributed Computational System and Method

(76) Inventor: Shirish Ranjit, Watertown, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/547,938

(22) PCT Filed: Apr. 12, 2005
(86) PCT No.: PCT/US05/12261

§ 371 Date: Oct. 6, 2006

Related U.S. Application Data
(60) Provisional application No. 60/561,383, filed on Apr. 12, 2004.

(51) Int. Cl. H04L 9/32; G06F 15/16; G06F 7/06; G06F 17/30

(52) U.S. Cl. 726/5; 709/201; 707/2; 707/E17.008

(57) ABSTRACT

A distributed computing system operates in a peer to peer (P2P) network to take advantage of idle or unused resources. The system facilitates the reception of a problem definition that can be picked up for processing by any peer in the network community on an anonymous basis. The peers in the network community are volunteers, and return solutions to a virtual space to be picked up by the entity proposing the problem. The problem and solution specifications are stored in circular first in first out queues, so that a number of solutions can be provided to any given problem definition.

### CROSS REFERENCE TO RELATED APPLICATIONS

The present application is based on and claims the benefit of U.S. Provisional Patent Application No. 60/561,383, filed Apr. 12, 2004, entitled “Peer-to-Peer Distributed Computing Applied to Prototypical Problems,” to which a claim of priority is hereby made and the entire contents of which are hereby incorporated herein by reference.

### STATEMENT REGARDING FEDERALLY SPONSORED RESEARCH OR DEVELOPMENT

### Background of the Invention

1. Field of the Invention

The present invention relates generally to peer-to-peer operational organization for distributed computing, and relates more specifically to a peer-to-peer network system and method for obtaining solutions to problems on a distributed basis.

2. Description of Related Art

Peer-to-peer networking has become popular in a number of applications for its features related to collaborative file sharing, resource sharing and distributed processing. A peer-to-peer network permits sharing of a number of resources, including files, storage and CPU processing time. A number of well-publicized applications have used the features provided in a peer-to-peer network to achieve results that otherwise would require large amounts of single point resources, including processing time and power.

Some well-known examples of peer-to-peer (P2P) networking applications include Napster, SETI@HOME and instant messaging communications applications.

The P2P model employed by Napster operated as an information sharing model to locate files for sharing among a large community. The model used by Napster is substantially different from the typical client-server model, which involves a single point of resources (the server) and a number of work stations connected to the single point (the clients), each of which are typically independent. At its peak, the Napster P2P network had approximately 75,000,000 subscribers sharing approximately 10,000 files per second. The popularity of the P2P network for file sharing underscores some of the advantages provided in a P2P network, including load balancing, dynamic information repositories, redundancy, fault tolerance, content-based addressing and improved searches. The main idea behind the Napster P2P network is efficient file sharing, where a file requester may obtain a specified file from any of a number of locations, depending upon availability and speed of transfer, for example.

Another model for information sharing in a distributed network provides for a number of computational machines doing small pieces of a large problem to arrive at a complex solution. These types of networks, while operating on a P2P type basis, are often referred to as distributed computing networks. An example of such a network is the SETI@HOME project, which seeks large numbers of volunteers to process small portions of a larger complex problem when computer resources are otherwise idle. The SETI@HOME model is a massively distributed computing network where the problem is divided into smaller tasks and each task is given to a participating client. A server keeps track of participating clients and their work units. If a participant fails to deliver results, the task is sent to a different participant. The server collects results and pieces together solutions that it receives from a number of clients to contribute to forming an overall solution. Each of the client machines is known to the server and may take several days to deliver their individual solution to the server.

Distributed computing is a collective way of working on a problem with a network of computers. It involves sending pieces of a problem to a number of computers in a network to obtain solutions that are pieces of a larger solution or goal. The individual solutions are independent of each other at the network computer level. The resulting solution or goal can mean, for example, finding a solution to a problem or executing an algorithm. Distributed computing typically involves decomposing a problem into smaller pieces so that smaller, less powerful computers can process the information to achieve the single goal. Most distributed computing models typically involve a server that manages data, connections to computers, and a community of computers that are analyzing the data.

Distributed computing typically involves a server that distributes the work units to idle PCs in a network, for example. If the computation is interrupted on one PC, the server sends the work unit to another idle PC. The PCs process each of their given work units and send results back to the server. The server manages all of the work and combines all of the results to produce the final product.

In one distributed computing architecture, a managing server sends tasks to sets of computers called first tier peers. Computers in the first tier request help from computers in a second tier. The second tier peers communicate to only one first tier computer. This type of architecture for distributed computing provides a cascading responsibility from managing server to peers on different tier levels.

It would be desirable to obtain a P2P network that efficiently provides solutions to distributed computing problems.

### BRIEF SUMMARY OF THE INVENTION

Briefly stated, in accordance with the present invention, there is provided a P2P network for obtaining solutions to distributed computing problems. An architecture is presented for a P2P distributed computing network that solves a problem broken down into a number of subsets of the overall problem. The subsets are made available to a P2P distributed computing model network consisting of computers with anonymous connections. That is, the computers do not know the identity of the entity requesting or delivering services.

The P2P distributed computing model in the present invention has publishers and acquirers, that provide requests and services for requests, respectively. Each of the subsets of the overall problem can be processed independently in the P2P distributed computing environment. Due to the nature of the P2P distributed computing network, any of the entities in the network can be a publisher, and any of the entities can be an acquirer, at any given time.

The P2P distributed computing network has a number of layers that are responsible for different operations in the P2P architecture. One or more layers are applications that reside on different peer computers. Other layers provide services that participate in communication among peer entities. A service layer may reside in a peer computer and provide services for all peers in publishing and acquiring subsets of the overall problem. The peer computers are volunteer computers that offer idle CPU time as a resource for the solution of discreet problem subsets. The architecture provides a medium through which volunteer computers communicate solutions to publishers of problems.

The P2P architecture uses a JavaSpace as a communication hub to permit publication of services and searches for solution requests. A JavaSpace is a network accessible shared memory space in which remote processors can participate concurrently. The entities of the P2P network publish problem subsets and results in the JavaSpace, and search for problem subsets and results.

JavaSpace consists of a number of services called Jini services, with communication facility provided through remote method invocation (RMI) between Java applications. The JavaSpace permits knowledge of services such as communication channels, storage devices, hardware and software devices, and so forth, to be made available to the members of the space. Jini provides a set of application programming interfaces (APIs) and network protocols for building distributed systems that are organized as federations of services. RMIs specify a set of APIs for applications to invoke processing on remote objects and to facilitate sharing of resources across systems through a network. The ability to invoke a method on a remote object offers a model for distributed operations on Java objects in a network. A method is a function in an object designed to accomplish a prespecified task.

The present invention provides an architecture for P2P distributed computing using JavaSpaces defined with Jini and RMI services. Volunteer peers within the networks may request problem subsets for processing from the JavaSpace, and return solutions to the same JavaSpace. The architecture of the present invention permits peer members to publish and acquire problem subsets according to an organized mechanism that provides efficient processing of problem subsets to rapidly achieve a number of solutions that can contribute to solving the overall problem.

### BRIEF DESCRIPTION OF THE SEVERAL VIEWS OF THE DRAWINGS

The present invention is described in greater detail below with reference to the accompanying drawings, in which:

FIG. 1 is a diagram of operations for registering a service;

FIG. 2 is a diagram illustrating finding and requesting a service;

FIG. 3 is a flow diagram illustrating processing of a problem subset in accordance with the present invention;

FIG. 4 is a diagram illustrating a high level architecture of the present invention;

FIG. 5 is a diagram illustrating the architecture of a communication interface in accordance with the present invention;

FIG. 6 is a diagram illustrating architecture of a communication interface in accordance with the present invention;

FIG. 7 is an illustration of a queue structure in accordance with the present invention;

FIG. 8 is an illustration of an abstract organization of a communication interface in accordance with the present invention;

FIG. 9 is a diagram illustrating architectural organization of operational functionality in accordance with the present invention;

FIG. 10 is a sequence diagram of operations of a publisher in accordance with the present invention;

FIG. 11 is a sequence diagram of operations of an acquirer in accordance with the present invention;

FIG. 12 is a diagram of a conceptual organization of services and resources provided in accordance with the present invention; and

FIG. 13 is a diagram of conceptual organization of an architecture of the present invention.

### DETAILED DESCRIPTION OF THE INVENTION

One of the goals of the present invention is to solve a CPU intensive problem using idle processing time available on network computers. The participation in the problem solving architecture by the network computers is voluntary. Any member in the architecture community may publish problems, or work units, and acquire solutions and/or process problems or work units to provide solutions. The members can join and leave the community at any time without impacting the operation of the community. The present invention provides a problem acquisition space that permits other member computers to acquire work units to contribute to solving the overall problem. A distributed communication space (DCS) is defined that permits members to publish a problem or work unit, and permits other members to acquire the problem or work unit to contribute to solving the problem in the DCS. Accordingly, problem acquirers obtain a problem from DCS, process the problem and publish solutions to the problems in the DCS. A communication interface is provided to each of the members of the network community to interact with the DCS. This interface, referred to here as a distributed communication client (DCC), is an application that resides in peer computers. The DCC provides services to permit communication among peers in the network. An illustration of the organization of such a member community network 130 is illustrated in FIG. 13. Network 130 includes peers P1-PN that communicate with the DCS through the DCC.

According to a feature of the present invention, an acquirer of a problem has the ability to obtain a transfer of a large data set directly from a problem publisher to speed network interaction and allow a number of computers to work on a given problem with a large data set. The data set is accessed through an index to permit the system to maintain anonymity while providing fast access to large data sets. The present invention provides the ability to process problems that are CPU intensive within a relatively short time frame to optionally obtain at least one solution.

The architecture of the P2P network does not constrain the solution to the problem, as long as the problem can be distributed for processing among a number of members in the network.

In the present invention, each of the problem subsets is called a work unit, which is easily distributed among the number of member computers. Typically, a problem has two components: data and a model of the problem to be solved. The model is a set of well-defined instructions for processing the data to produce a solution. A ticket is defined as an object class that contains both model and data information related to a problem, or a solution to a problem. The ticket may contain either a reference to a model and data, or an actual payload of model and data information.

In the architecture, a publisher is a member of the volunteer community that-propounds a problem that may be CPU intensive and desires one or more solutions to the problem. A problem is published into a DCS by the publisher, where it is available for processing by other member computers that have volunteered to make themselves available. In an exemplary embodiment, the publisher has a well-defined problem with model information and a data set. The system generates a ticket that contains either a reference to a file that can contain the model information and the data, or the model information and data may be provided directly as a payload in the ticket. The ticket is then published into a DCS, which is a structured form of a JavaSpace.

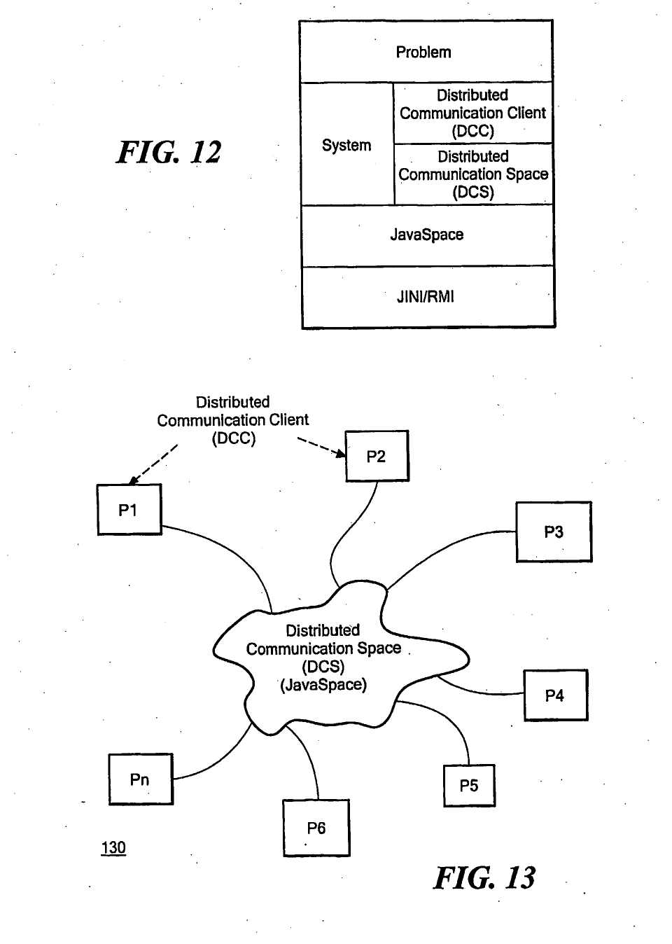

The fundamental JavaSpace used to form the DCS consists of Jini and RMI technologies to permit the construction of a dynamic distributed system among a network of virtual machines. Jini uses RMI to move objects within the network, while the JavaSpace framework has built-in mechanisms to permit members to join and leave the network dynamically and randomly. Jini services may be any number of defined resources available among the members of the JavaSpace. For example, a service may be a simple computational program, a storage device, or a communication device. A diagram 120 illustrates a conceptual organization of the present invention in terms of layers and services in FIG. 12.

Services are identified through a protocol involving a service provider, and made available to any other members of the JavaSpace. Jini provides a framework for developing an infrastructure that defines, registers and consumes services. There are three basic protocols that are provided in the Jihi framework, namely, discovery, join and lookup. These protocols are the basis of a scalable distributed system within the Jini framework.

The discovery protocol is used to lookup a service in the network, which permits members, to join the network as a service provider or a consumer of the service. Once a lookup service is located, a member can register as a service provider in the lookup service, or scan the lookup service for available services and their providers. Typically, discovery protocols can take the form of multicast requests, multicast announcements, and unicast messaging to determine lookup services and identify the service characteristics. Multicast requests are provided as a particular service consumer that generate a multicast to discover nearby lookup services. Multicast announcement is a lookup service that multicasts its various locations to the remainder of the network. The unicast protocol is a simple request-response protocol to discover lookup services.

Another protocol in the Jini framework is the join protocol. The join protocol provides a registry of a service in one or more lookup services in the network. A service provider uses the discovery protocol to locate a lookup service, and then the join protocol permits the service provider to register its service in the lookup service. If a new service is identified in the network, the lookup service broadcasts the availability of the new service.

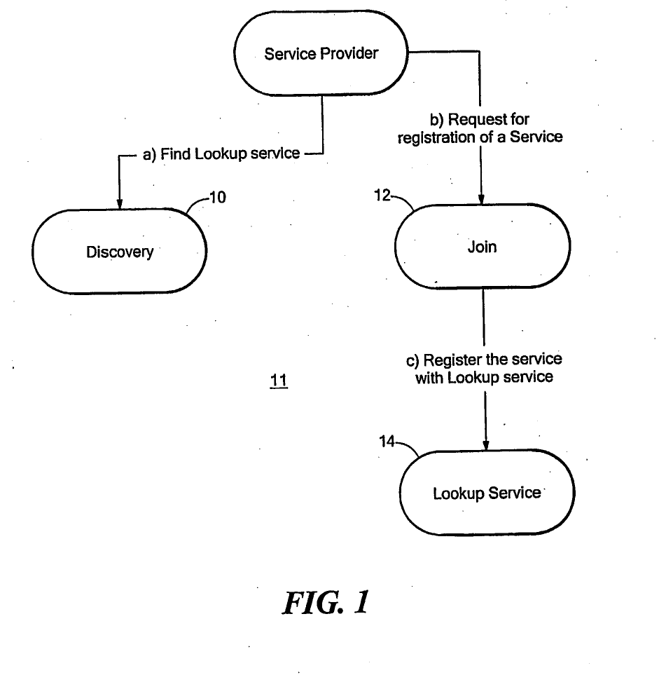

Another protocol in the Jini framework is the lookup service protocol, in which consumers of services find and resolve services using an address of a service provider. The service consumer uses the address to request services from the service provider. A lookup service provides a registry of services available within a Jini system and maintains a directory of service items that are instances of available services. For example, when a service is registered with a lookup service, the service object contains a Java API for the service, such that a consumer can invoke the API to request the service. A consumer can query the lookup service to find a desired service, which may return the API of more than one service provider. The consumer then simply requests the service through the given API. A diagram of the protocols in relation to the service provider is illustrated in FIG. 1. A service is registered according to the diagram by first finding a lookup service 14 using a discovery protocol 10. The service is then registered using join protocol 12 in look up service 14.

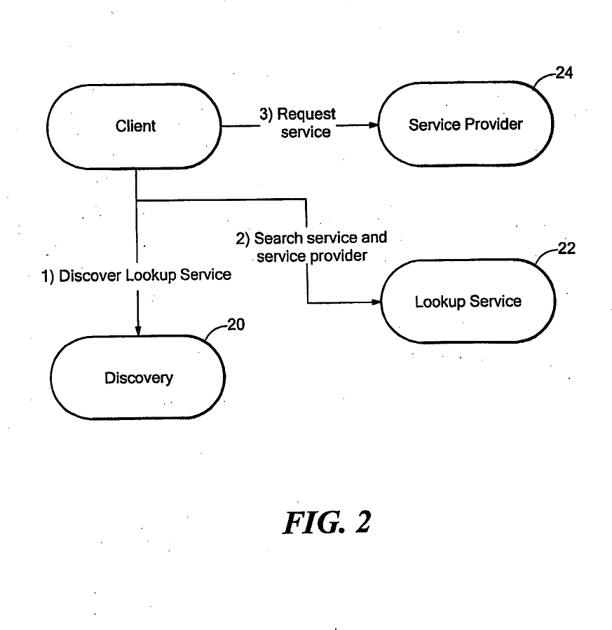

A service consumer uses the discovery and lookup service protocols to find a service and a service provider. FIG. 2 illustrates a process for finding and requesting services. To begin with, a lookup service is sought using discovery protocol 20. The desired service and service provider are then found in lookup service 22. The service consumer may then request the service from service provider 24.

With these tools, the foundation for a distributed computing system can be developed within a JavaSpace specification.

JavaSpace instances may also be provided with security measures to permit mutual authentication between service providers and consumers. The security measures permit authorization and integrity checks, such as cryptographic check sums, and encryption to provide a framework for trust verification and a constraint-based remote invocation model. The constraint-based model permits applications to specify various security requirements for remote invocation. The specific security requirements give the service provider a channel with which to effectively shield itself from unwanted operation. Security requirements may also be dynamically changed for a given application.

RMI permits the movement of objects across a P2P network. RMI also provides a communication vehicle among distributed objects so that seamless communication in a specified JavaSpace may take place.

A JavaSpace is an abstract shared memory that permits object storage and distribution. Active programs can exist within the JavaSpace over physically dispersed processors, while unaware of each others existence, yet able to communicate with each other. Communication between active programs takes place through the release of data, or a tuple, into a tuple space. Programs read, write and take tuples from a tuple space that are of interest to the programs. Finding and using an object in JavaSpace by a member occurs through the discovery, lookup and join protocols discussed above. Members of the JavaSpace obtain a local copy of an object that the member, or program, wishes to use to invoke an available method. This architecture permits members to execute methods on objects that are otherwise unknown to the programs. This type of architecture and operation is also known as dynamic code downloading.

Members of the JavaSpace can write an object to the JavaSpace through the use of an entry interface in the object. Objects may be standardized so that any JavaSpace member can easily process information in an object without having prior knowledge of the object.

The above described tools and characteristics of a JavaSpace are used in the design of the DCS according to the present invention. When a publisher publishes a ticket into a DCS, a number of the protocols and methods of available objects may be invoked. The DCS into which the ticket is published therefore provides all the services needed to complete a given task. When a ticket is published into the DCS, with a reference to model information and data, the model information and data are provided to the acquirers of the problem unit. The publisher checks periodically to determine whether a solution is available in DCS, and if so, obtains solution tickets from the DCS. A solution ticket may contain a reference to the solution provided by the acquirer, in which case, the publisher requests the solution from the acquirer. If the solution ticket contains the solution information itself, the ticket is unpacked and the solutions are saved with reference to providing an overall solution to the overall problem. If the solution provided in the DCS is unacceptable to the publisher, the problem can optionally be left in the DCS for pickup by another acquirer. If the solution is acceptable to the publisher, the problem can be removed from the DCS.

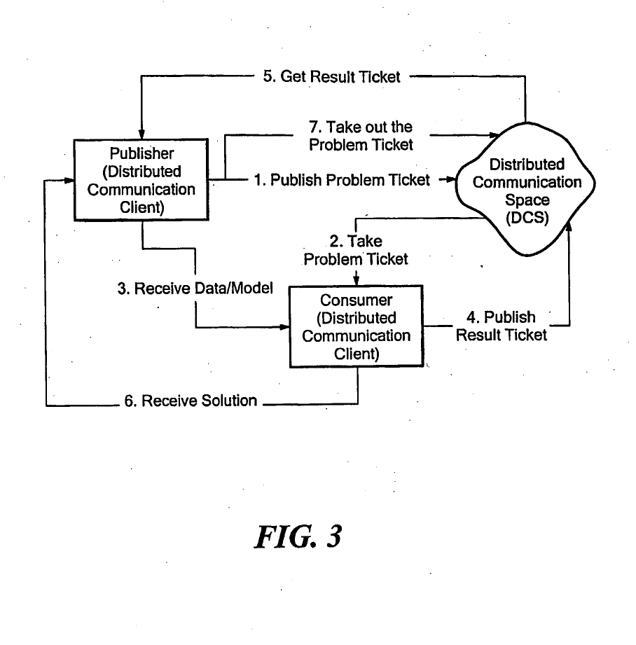

A problem acquirer in the volunteer community of the P2P network checks the DCS occasionally for a ticket that contains a problem. Upon locating a ticket, the acquirer takes the ticket from the DCS and determines whether further accesses to model information and data must be made. The acquirer then begins processing the work unit, typically on a low priority basis. Once processing is complete, a solution ticket is generated, including, for example, model information and solution data or a reference to the model information and solution data. The ticket is then published to the DCS. The publisher periodically checks the DCS to determine if a solution is available and removes the solution ticket if the found solution is acceptable. A flow diagram illustrating the roles of the publishers and the acquirers is illustrated in FIG. 3.

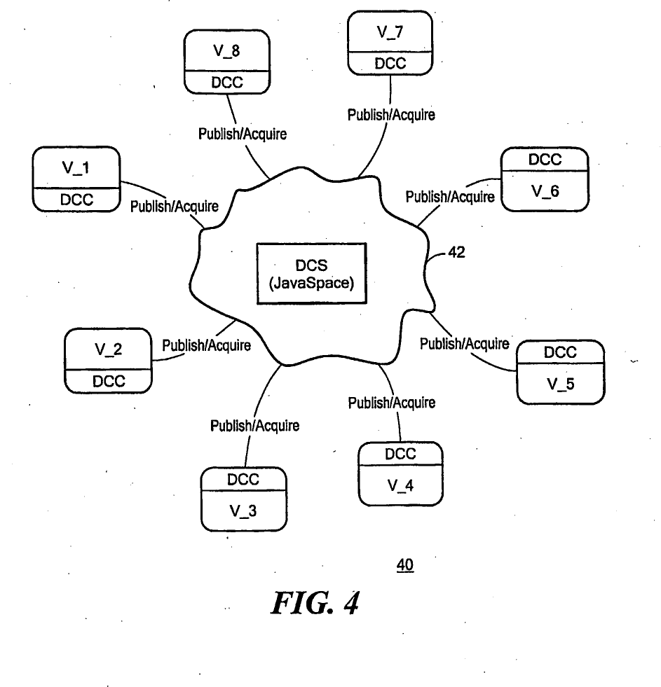

Referring now to FIG. 4, a description of the architecture of a P2P distributed computing network according to the present invention is illustrated generally as architecture 40. In architecture 40, member computers V1-V8 all include a distributed communication client (DCC). The DCC is a client program that is installed locally to each of the member computers V1-V8. Members V1-V8 are able to publish problems in DCS 42 using the DCC client program. The DCC client program is also used to acquire solutions from DCS 42. In accordance with this exemplary embodiment of the present invention, members V1-V8 are anonymous to each other, or are not aware of the existence of each other. Each member V1-V8 may simply be aware of the DCS, so that they do not know who is asking for a solution to a problem, nor who is solving the problem. The DCC is a P2P networking application that is used with the DCS architecture.

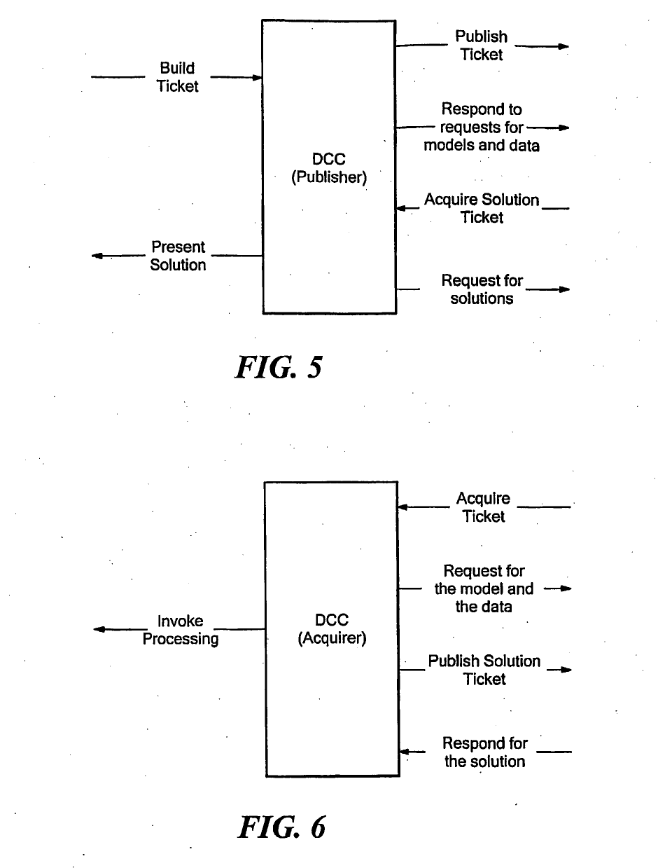

When a publisher wishes to publish a problem to obtain a solution, the publisher instructs the DCC to build the ticket that describes the model and the data for the problem. The DCC then publishes the ticket into the DCS, and the publisher waits for a solution or solutions. The publisher periodically checks the DCS for reported solutions, and retrieves and processes any solutions that are received. FIG. 5 illustrates an abstract architecture of the DCC when used with a publisher.

An acquirer of a problem is a member of DCS 42 that is prepared to make itself available to work on a problem. The acquirer obtains a ticket from the DCS and takes advantage of unused or idle CPU resources to provide processing for the problem in the acquired ticket. When the acquirer finishes processing the problem, a solution ticket is constructed that contains the completed work. The solution ticket is published in the DCS for consumption by the relevant publisher. The resources used in completing the processing are freed in the acquirer, and the acquirer is free to obtain another problem ticket. An abstract view of the architecture for a DCC from the perspective of an acquirer is illustrated in FIG. 6.

The common points of the publishers and acquirers in the above-described architecture provides fundamental characteristics for the DCC. For example, the DCC can find the DCS, create and decipher tickets, read and write problem tickets from and to the DCS and read and write solution tickets from and to the DCS. In addition, the DCC can respond to requests for model information and data as well as responding to requests for solutions. The DCC supports publication of problems and solutions to the DCS as well as the acquisition of problem and solution tickets from the DCS.

While the DCS is defined as a particular case of JavaSpace, it has a unique architecture that permits construction of a P2P distributed computing environment in accordance with the present invention. A given DCS is accessible by the members of a networked environment such as the internet, a WAN or LAN. The DCS architecture supports members joining and leaving the network community with little or no impact on the system. A member of the community that volunteers for the P2P distributed computing system can join in the system to publish or acquire a problem to be solved by installing a DCC and finding a DCS. The DCS architecture supports these new volunteers in joining the system, and also permits members to leave the network on a random basis. In an exemplary embodiment of the present invention, a member wishing to leave the system simply ceases to communicate with the DCS.

To achieve the desired functionality for the DCS, where members can publish and acquire problems and results and join and leave the community at will, the DCS is provided with a number of channels. One of the channels is structured for delivery of problems by a publisher, while another channel provides the structure for delivering solutions from acquirers. In the present application, the channel designated for delivery of problems is referred to as the work unit publication channel (WPC). The channel designated for solution delivery is referred to as the solution publication channel (SPC). Publishers and acquirers use the WPC and SPC to anonymously communicate problems and results with each other. A publisher publishes problem tickets in the WPC, while an acquirer looks for problem tickets in the WPC. Once an acquirer completes the processing of a problem, the solution ticket is published on the SPC. A problem publisher searches for solution tickets in the SPC to complete a two way communication loop for delivering problems to a P2P distributed computing environment and receiving solutions from the environment.

The WPC and SPC channels are defined as circular queues that operate on a first in first out (CFIFO) basis. The queue structure permits members in the P2P environment to operate using queue type operations, such as enqueueing, reading and dequeueing. The queue provides a structure that acts as a place holder for problem tickets in the case of the WPC and solution tickets in the case of the SPC. Tickets may contain digital signatures to permit authentication before operations are allowed on the queue. For example, a publisher may be entitled to place or remove a ticket in the queue, which ticket is inaccessible by any other publisher. Publishers may search a queue such as the SPC to dequeue tickets that belong to them.

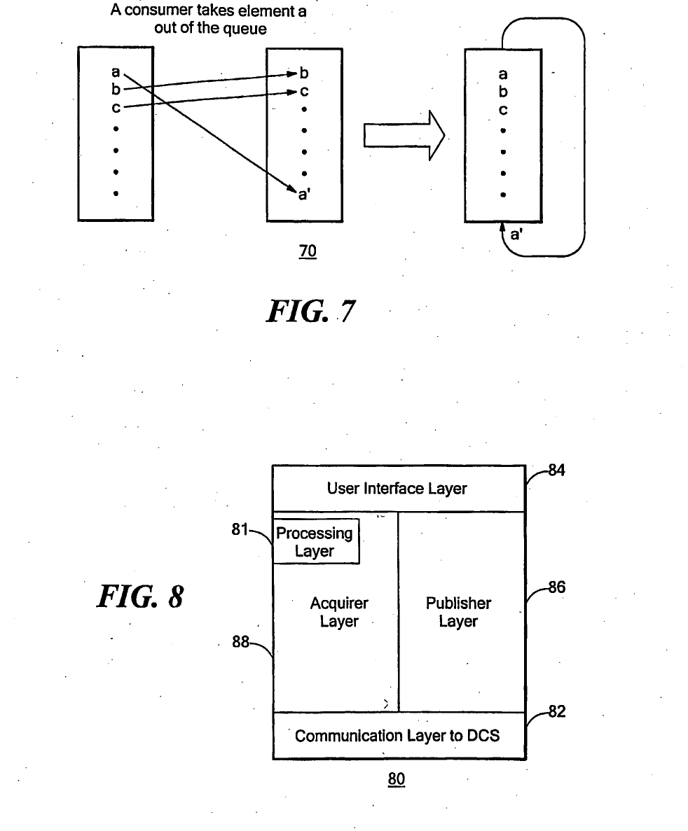

The WPC queue provides a structure to permit more than one acquirer access to a given problem ticket. Additionally, publishers may remove problem tickets from the WPC queue, such as in the case of very long processing times. To meet the needs of the WPC queue, the CFIFO queue structure permits the removal of a problem ticket from the queue, and requeues a copy of the removed problem ticket. This concept is illustrated in diagram 70 of FIG. 7, in which a WPC queue has elements a, b and c in that order. When an acquirer removes the first element a from the WPC queue for processing, element a is immediately requeued as element a′, which is a copy of the removed element a. Accordingly, the order of the WPC queue changes to b-c-a′.

According to this design, a CFIFO queue structure permits more than one acquirer to work on the same problem found in the WPC queue. In an exemplary embodiment, if a single ticket is provided in the queue, all acquirers receive the same ticket. A number of different tickets in the queue indicates that acquirers receive different tickets depending upon how tickets are requeued. That is, one ticket may be picked up from the queue by more than one acquirer. This organization of the WPC queue provides a powerful design for distributed processing, where more than one member of the P2P distributed computing environment can work on a given problem at any given time. Consequently, many acquirers can work on the same problem until a solution, or multiple solutions, are obtained.

The CFIFO queue structure provides the possibility that a problem may exist in the queue indefinitely. Accordingly, the P2P distributed computing environment is constructed to place responsibility for removing the problem from the WPC queue on the publisher. Each publisher may have different criteria for removing a problem from the WPC queue, such as a satisfactory number of solutions, a lengthy processing time, and so forth. According to an exemplary embodiment to the present invention, only the publisher of the problem is permitted to remove the problem from the WPC queue. In this embodiment, each problem may contain a digital signature to permit the publisher to authenticate themselves for ticket removal.

Because the members of the P2P distributed computing environment are defined to have the ability to join and leave the environment at will, it is possible for a publisher to disappear from the environment while a problem ticket still persists in WPC queue. Accordingly, an exemplary embodiment of the present invention provides for an expiration time on tickets that can be set arbitrarily depending upon the characteristics of the publisher or problem to be solved. Once the expiration time on a ticket passes, it is automatically removed from the queue to prevent tickets from residing in the queue indefinitely.

Each of the above-described structures for the WPC queue can be made applicable in the SPC queue as well. Accordingly, if a publisher disappears from the environment, a ticket residing in the SPC queue may exist in the queue indefinitely without the provision of a mechanism for removing the ticket from the queue, such as an expiration time. The design of the WPC and SPC queues thus provides a flexible and simple architecture for supplying problems and retrieving solutions in a P2P distributed computing environment.

Another feature of the present invention is the DCC, which resides on each of the peer computers in the P2P environment. The DCC is an application that can locate a DCS and communicate tickets to and from the DCS. The DCC is organized so that the member on which the DCC resides can be defined as a publisher or an acquirer. Typically, the DCC is organized as a structure containing a number of layers that permit reserved areas for different tasks. A DCC layer design 80 is illustrated in FIG. 8 with four layers. A communication layer 82 provides interaction between the DCS and the peer computer to permit an acquirer layer 88 and a publisher layer 86 to have access to the DCS. Communication layer 82 provide utilities and APIs to locate a DCS, connect acquirer layer 88 and publisher layer 86 of the peer computer to the DCS, and to make requests to the DCS. A user interface layer 84 permits users to interact with the DCC and to issue publish and acquire commands. Publisher layer 86 provides the functionality to develop and implement a problem ticket. Acquirer layer 88 provides all the functionality for acquiring a problem ticket to begin processing a problem. Acquirer layer 88 includes a processing sublayer 81 that interfaces acquirer layer 88 with external system in the host peer computer to process acquired problems.

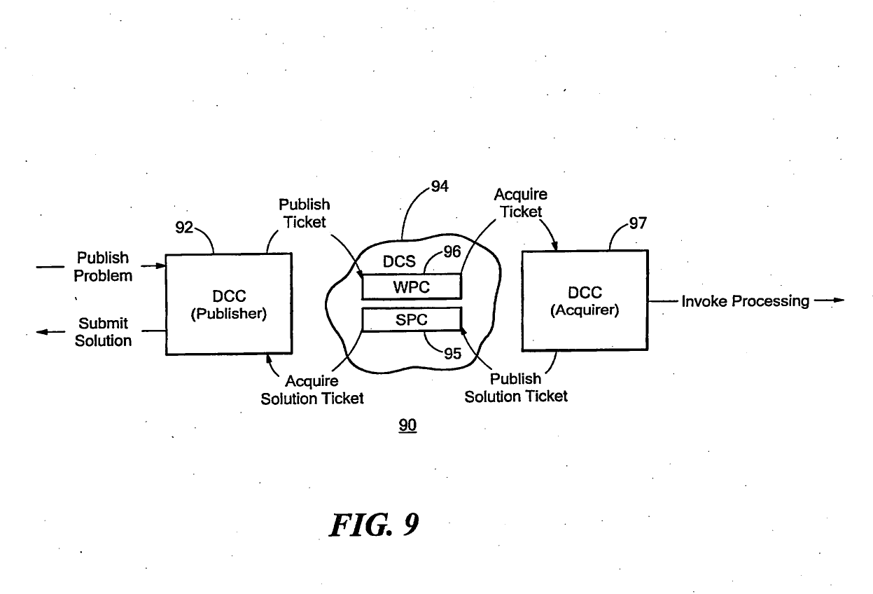

An overall high level structure of the P2P distributed computing environment is illustrated as structure 90 in FIG. 9. A peer computer provides a problem to publish through DCC 92, which communicates with a DCS 94 to place a problem ticket in WPC queue 96. An acquirer reads a ticket from WPC 96 through their DCC 97 and can invoke processing on the acquired ticket. The solution obtained by the acquirer is also passed through DCC 97 to DCS 94, and placed in SPC queue 95. The problem publisher reads SPC queue 95 through DCC 92 and determines when the solution ticket is available. The solution ticket is read from SPC queue 95 and passed through DCC 92 to the problem publisher, which can then decide whether more solutions are desirable, or if the problem should be removed from WPC queue 96.

The above-described structure and organization for a P2P distributed computing environment obtains many advantages over prior distributed computing environments or P2P network structures. These advantages can be measured in computing terms related to such issues as latency, memory access, partial failure, concurrency and synchronization.

The architecture of the present invention is designed to provide solutions to time consuming problems that require large numbers of processing resources. In addition, the architecture permits passage of large data sets to a number of processing resources, such as, idle peer computers.

However, when a large data set is passed between peer computers, or complex computations are conducted, a time lag typically develops between the computers in the network, referred to as latency. In the architecture of the present invention, the latency is determined by the time lag found in communications between the DCC and DCS portions of the environment. According to an exemplary embodiment of the present invention, the ratio between latency and computing time in the P2P network environment is very low. For example, transfer of data may take twenty seconds, while computing time may be on the order of twenty hours. In a given network environment, the data acquisition time may seem significant, however, the latency time is insignificant in the P2P distributing architecture given the nature of the problems to be solved and the selected low ratio of latency to computing time.

Due to the defined characteristics of the members of the P2P network, an acquirer may join or leave the environment at any given time. Accordingly, an acquirer may obtain the problem ticket and fail to respond with a solution. This scenario is anticipated in the P2P architecture of the present invention and designed to have minimal consequences in the system. An acquirer that obtains a problem ticket is completely responsible for the solution and processing of the problem, and has the simple option of not providing a solution. It is possible that a system, network or hardware failure may cause the volunteer peer to abandon processing or cease communicating with the DCS. This type of partial failure is designed to have minimal consequences with the view that there is a high probability of another volunteer peer member responding. Because the members of the P2P environment are communicating problems and solutions independent of each other's behavior, partial failures are acceptable. A number of members may obtain the same problem ticket and provide a number of different solutions dependent upon their own unique characteristics, without regard to behavior of others members in the network. The architecture decouples the members from the problem environment, in the sense that none of the members is required to provide a solution to the problem in the acquired problem ticket. In addition, a publisher of a problem may receive more than one response to a problem published in the WPC queue. Accordingly, problem publishers have the additional constraint or definition that they are able to handle multiple solutions from several different problem acquirers. This distributed processing solution makes the P2P environment of the present invention a powerful tool in providing solutions to computationally intensive problems.

Since the DCS of the present invention is implemented as a JavaSpace, concurrency is handled automatically through the JavaSpace subsystems. As it is likely that multiple peers may try to access the same resource, the transactional processing provided in the JavaSpace permits concurrent processing to avoid resource hogging.

The architecture provided according to the present invention is scalable, since it allows any number of members to join or leave the community at will and very simply. However, if a large computationally intensive problem is presented to the P2P distributed computing network, a request may be made for a number of volunteers to join in solving the problem. In addition, if there are a number of idle or unused resources, a number of members, can solve the same problems and provide a number of solutions to the problem publisher.

The system is also fault tolerant because any problem acquirer is permitted to fail to respond, with the problem being picked up by another member of the system obtaining a copy of the problem ticket. If a problem publisher is removed from the network, the tickets of the publisher remain in the DCS in the SPC queue and are available when the problem publisher returns to the system. This convention presumes a ticket expiration is set to be long enough to permit a publisher to leave and come back and receive the solution ticket in the queue.

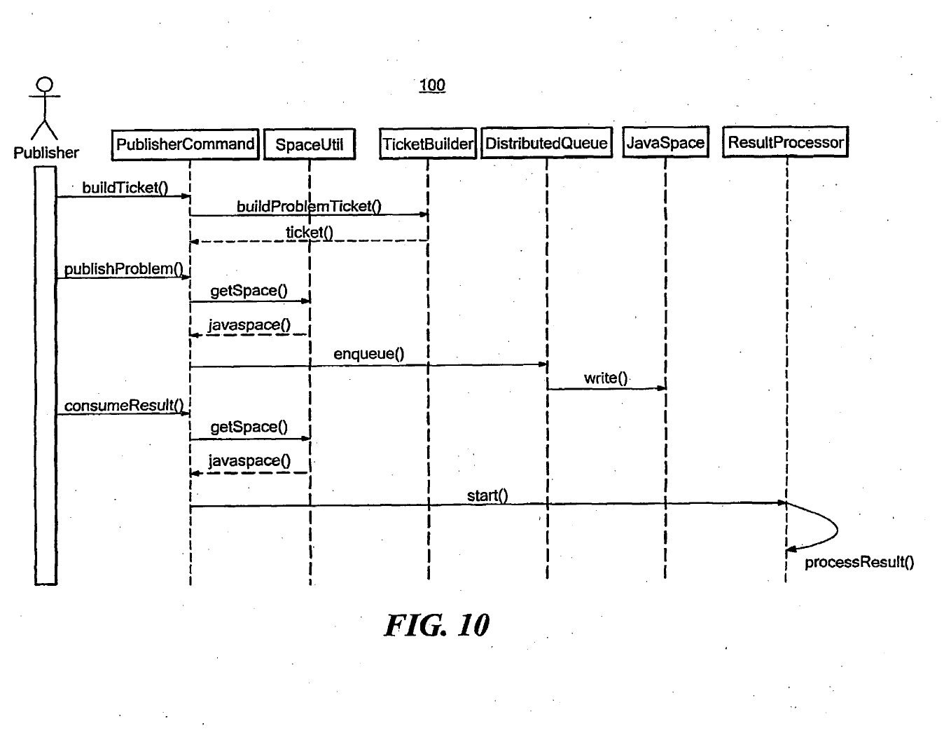

Referring now to FIG. 10, a sequence diagram 100 shows the operations that take place for a publisher when publishing a problem. A publisher command object makes a call to a ticket builder object to build a ticket with a problem. The publisher command object then makes a call to a space utility object to locate a DCS. Finally, the publisher command object makes a call to the distributed queue object to queue the problem ticket in the WPC of the DCS.

Once a problem is published to the WPC, the problem publisher can check the SPC queue by making a call to the publisher command with the consume-result method. The publisher command object then calls on the space utility object to find the DCS, and calls on the result processor object to process the results from the SPC queue and the DCS. The SPC queue is searched using the result entry object and the DCS, and any identified results are encapsulated in the result entry object. The results are then provided to the publisher for review.

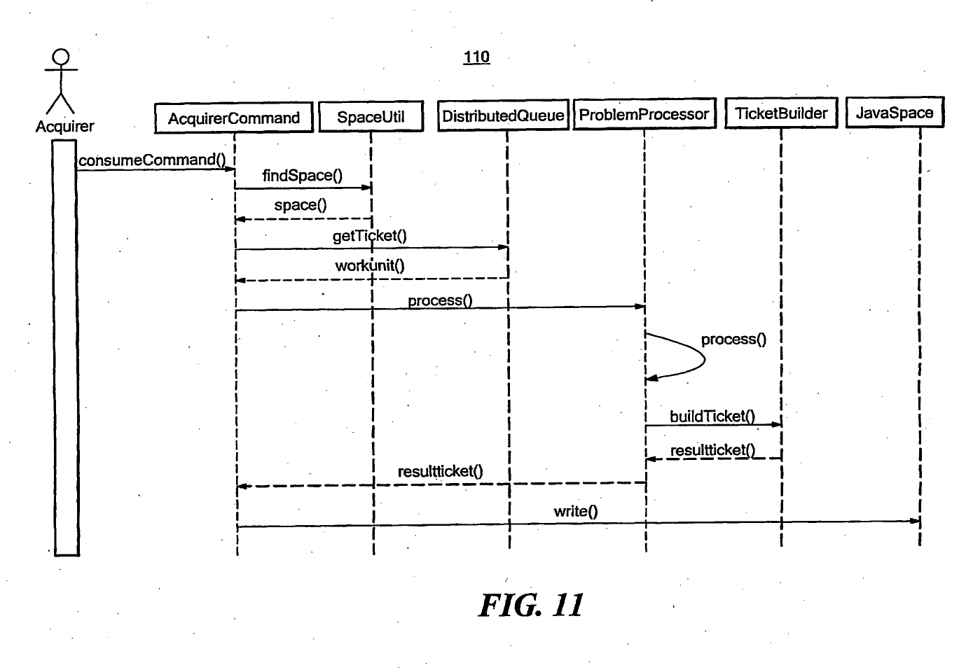

Referring now to FIG. 11, a sequence diagram 110 is illustrated for a problem acquirer. Similar to the problem publisher, a consumer command object calls on the space utility object to locate the DCS. Once the DCS is located, the distributed queue object is tasked to obtain a ticket from the DCS and the WPC queue. As a ticket is obtained, the problem processor object processes the ticket and generates a result. The result consists of a result entry object from the problem processor object, which is published in the DCS and the SPC queue.

The realization of the system and the various volunteer peers of the network includes the DCC located in each peer. The DCC provides a graphical user interface (GUI) that permits the user to define their interaction with the P2P distributed computing network. For example, the GUI permits the user to define themselves as a publisher or acquirer for a given instance. For example, the publication of a problem through the GUI loads the selected problems into the DCS, while another option in the GUI permits the user to acquire solutions to the problem for display to the user. The GUI offers a remove-problem selection to dequeue particular problems offered by the problem publisher. Similarly, an acquirer can be activated through the GUI by selecting an option to acquire a problem. The acquirer obtains the problem ticket, processes the problem, creates a result object and publishes the result object to the DCS and the SPC queue.

The P2P distributed computing network of the present invention provides a number advantages over prior distributed computing systems or P2P networks through the use of a unique architecture in a JavaSpace. The present invention permits the use of multiple JavaSpaces that can be accessed by, any number of members. Each DCS is constructed to have several queues including a problem queue and a solution queue, each of which are organized as circular FIFOs. The circular FIFO or CFIFO, permits the problem publishers and problem acquirers to operate in anonymity. According to a feature of the present invention, large data sets are not provided directly to the DCS, but rather are indexed to permit anonymous access by a problem acquirer. Each ticket that is developed for either a problem specification or a solution specification may have clearance or authentication data attached to it which provides for a parametric value to distinguish between which members of the P2P community may offer problems or accept specific problems for processing. Such a configuration indicates the flexibility provided by the DCC to establish clearance levels on an individual basis for peer computers, while maintaining anonymity. Clearance may refer in the abstract to specific issues of network access that may be related to security, processing power, specific processing functionality or other types of definitions for members that may be specific to hardware, software or performance. Tickets may also encode a given priority level, so that an acquirer may select a specific problem ticket based on a given priority scenario.

Although the present invention is described in relation to the solution of large scale, resource intensive computing problems through a P2P distributed computing architecture, a number of other applications are readily available. For example, the present application may be used in concepts applicable to advertising. One example is a number of consumers in a retail environment that may connect to a P2P network using portable devices such as mobile phones or PDAs. The consumer may join in the network as a problem publisher or a solution provider, depending upon how the architecture is structured. For example, the consumer may propose the problem of finding a particular item on sale in any of the given retail establishments in a nearby location, such as a shopping mall. Solutions may consist of sale items published to the consumer, which the consumer may then select for purchase, or other options. Alternately, the consumer may be set up as a problem acquirer, such that a solution provided by the consumer is the selection of an item for purchase. In such a P2P network, the present invention may provide broadcast messaging for available problem tickets or solution tickets.

Finally, it will be appreciated that modifications to and variations of the above-described system and method may be made without departing from the inventive concepts disclosed herein. Accordingly, the invention should not be viewed as limited except by the scope and spirit of the appended claims.

What is claimed is:

1. A distributed computing system, comprising:
a virtual space accessibly a plurality of computers on a network, the virtual space providing a framework for interaction between computers on the network;
a memory structure in the virtual space for storing one or more of a distributed computing problem and a distributed computing solution;
a problem proposer entity coupled to the virtual space and operable to deliver a problem specification to the memory structure and receive solution specifications from the memory structure; and
a problem acquirer entity in the network and coupled to the virtual space, operable to acquire a problem specification from the memory structure, process the problem specification and deliver a solution specification to the memory structure.

2. The system according to claim 1, wherein the memory structure is a queue.

3. The system according to claim 2, wherein the queue is structured as a circular first in first out (CFIFO) queue.

4. The system according to claim 1, further comprising a communication application resident on computers in the network participating in the distributed computing system, the communication application being operable to couple the participating computers to the virtual space.

5. The system according to claim 1, wherein the memory structure further comprises a plurality of queues.

6. The system according to claim 5, wherein one of the queues is a problem specification queue, and another of the queues is a solution specification queue.

7. The system according to claim 6, wherein the problem and solution specification queues are circular first in first out queues.

8. A method for distributed computing in a network of computers, comprising:
supplying a problem specification from a problem delivery computer in the network to a virtual space having a storage structure for the problem specification;
retrieving a problem specification from the memory structure in the virtual space by a problem acquirer computer;
processing the problem specification at the acquirer computer to produce a solution specification;
delivering the solution specification to the virtual space memory structure; and
retrieving the solution specification from the memory structure by the problem providing computer.

9. The method according to claim 8, further comprising storing the problem specification in a CFIFO in the memory structure.

10. The method according to claim 8, further comprising storing a solution specification in a CFIFO in the memory structure.

11. The method according to claim 8, further comprising providing a security authentication in the problem specification to permit the problem specification to be securely identified with the problem deliverer.

12. The method according to claim 8, further comprising removing a problem specification from the memory structure by the problem deliverer.

13. The method according to claim 11, further comprising authenticating a removal request from the problem deliverer for the problem specification based on the security authentication.

14. The method according to claim 13, further comprising removing the problem specification from the memory structure by the problem deliverer.

15. A program code for operating a distributed computing environment, comprising the method of claim 8.

16. A special purpose processor formed by the execution of a program, the program comprising:
a first code section for a communication interface providing communication between a local memory and a virtual space including one or more objects;
a second code section for a problem specification transmission and a solution specification reception to or from the virtual space through the communication interface;
a third code section for retrieving a problem specification from the virtual space through the communication interface; and
a fourth code section for processing a problem specification and delivering a solution specification to the virtual space through the communication interface.
